(19) United States
(12) Patent Application Publication
(10) Pub. No.: US 2006/0179479 A1
(43) Pub. Date: Aug. 10, 2006

(54) Secure computer network arrangement using directed circuits

(76) Inventors: John Cook, Southborough, MA (US); Kathy Kaminski, Marlborough, MA (US)

Correspondence Address: MCGLEW & TUTTLE, PC, P.O. BOX 9227, SCARBOROUGH STATION, SCARBOROUGH, NY, 10510-9227, US

(21) Appl. No.: 11/054,295

(22) Filed: Feb. 9, 2005

(51) Int. Cl. G06F 15/16

(52) U.S. Cl. 726/11

(57) ABSTRACT

Two private networks are connected to each other through a public network. A first of the private networks has a firewall which prevents unsolicited messages from the public network into the first private network. The firewall does allow messages from the first private network on to the public network, and then on to the second network. The firewall also allows messages from the public network into the first network, if the message is in response to a message originating within the one network. The first network periodically sends status messages to the second network. The second network can respond to the status messages, and requested that the first network establish a directed circuit with the second network. However, the time period between status messages can be excessively long. Therefore, a wedge message, which is smaller and more frequent, is sent from the first network to the second network. The second network sends a response message to the first network. When the first network receives the response message, the first network prematurely sends the status message.

### FIELD OF THE INVENTION

The present invention relates to secure computer networks, and in particular to improving the time to establish a direct circuit between two parties through a public network. The establishment of directed circuits is described in applicant's co-pending U.S. patent application Ser. No. 10/796,949 filed Mar. 10, 2004, and this entire application is incorporated by reference.

### BACKGROUND OF THE INVENTION

An example of a public network would be the Internet. There are many private networks that are connected to the Internet, usually through a firewall. This allows the users of the private network to communicate amongst themselves, share and modify files amongst themselves, and still communicate with persons in the public network without having those persons in the public network modify files within the private network. The firewall allows the users of the private network to communicate with the public network, but the firewall doesn't allow persons on the public network to have control inside the private network.

However, sometimes it is desirable for a user in one private network to control a device in another private network through a public network. One way to do this is to establish a directed circuit between the two private networks. There are many different types of directed circuits which are known and available to the person of ordinary skill in the field of computer networks. Therefore, it is unnecessary in this application to discuss how a directed circuit operates. A directed circuit is considered to be a very secure communication path between two users in different private networks and through a public network. Establishing a directed circuit requires an initial degree of trust, especially with regard to the identity of the two users establishing the directed circuit. Also, establishing a directed circuit requires a substantial amount of configuration in each of the private networks. Applicant's above-mentioned patent application describes applicant's preferred arrangement for establishing a directed circuit.

Directed circuits are secure point to point connections that are established between a secure access appliance and a controller in response to a request made by a director as previously described in the co-pending application. In this model both the director and the controller reside within the director network. The secure access appliance resides within a protected private network at a satellite site. To better protected the satellite site, the appliance operates behind a firewall and is therefore not directly addressable by the director. To report monitored statistics to the director the appliance periodically (typically each minute) sends a status message to the director. This message has previously been described in the co-pending application as a secure HTTP request containing an XML document: also called a heartbeat. Being an HTTP message, the director has the opportunity to send a request to the appliance within the HTTP response. This HTTP response is also an XML document, and it may be used to initiate a directed circuit. The same heartbeat request/response mechanism is used to communicate with the controller.

Again, since the appliance is behind a firewall and therefore not publicly addressable, a directed circuit between the appliance and the controller must be initiated by the appliance. (Note: the controller must have a public address in order for the appliance to address the controller when establishing a directed circuit.)

For further security reasons, the controller will not accept directed circuit requests from an appliance until it is instructed to do so from a director. Furthermore, the appliance will not attempt to establish a directed circuit with the controller until it is instructed to do so from a director. For further security, a controller must be prepared to accept a directed circuit prior to the appliance's attempting to establish the same.

Being that the controller must send a heartbeat to the director and be instructed in a heartbeat response from the director to post a listen for a directed circuit, and then the appliance must send a heartbeat and be instructed in a heartbeat response to establish a directed circuit, it may be as long as two minutes (the worse case heartbeat alignment) to establish a directed circuit. The statistical average amount of time is one minute.

One method for speeding up the process of opening a directed circuit would be to hold open connection between the controller and appliance. However, since these connections are HTTP and therefore require a TCP connection, this would be both insecure as well as resource intensive in large scale operations. A second method for speeding up the process of opening a directed circuit would be to decrease the period of time between heartbeat messages. However, since the director plays such a critical role in the system, overburdening the director would have dire consequences.

### SUMMARY OF THE INVENTION

It is an object of the present invention to reduce the potentially large delay associated with establishing directed circuits.

The present invention proposes to use a preferably proprietary protocol over UDP. Since UDP is a connectionless datagram service, the same security and resource concerns do not exist. However, the problem still remains that the appliances are not directly addressable by the director. However, by taking advantage of the fact that firewalls will hold open a window for UDP protocols to respond to UDP datagrams sent through them, the present invention exploits this facility to wedge open a return pathway for unsolicited messages to be sent from the director to the appliance. This unsolicited message is used to indicate that the traditional heartbeat should be sent immediately rather than waiting for the next regularly scheduled periodic heartbeat.

To create the wedge, appliances send a UDP packet to the director on a periodic basis (for example every thirty seconds). Since UDP is a datagram service, each of these wedge packets is one packet vs. the 14+ packets required by a secure TCP connection.

When a wedge packet is sent by an appliance to a director, the source address and port are stored in a network address translation (NAT) table on the firewall protecting the appliance. The firewall then uses its external address and an unused UDP port to replace the original source address and port. This enables the receiving director to associate a public address and port with the appliance. Later upon a request for a directed circuit, the director can send a UDP packet back to the public address and port associated with the appliance which then gets translated back to the address and port of the appliance on the private network by the firewall.

Using this technique multiple appliances may reside behind the same firewall and still uniquely communicate with the director. This is due to the fact that each appliance's source address will be NATed to a different source port on the firewall. Depending on how long the firewall at hand preserves the NAT entry, the period between wedge messages must be tuned on the appliance.

In order for the director to identify the appliance that is sending the message, some artifact must be communicated in the wedge packet. The exact nature of the artifact can be left to the user or operator and does not need to be further described. It is preferable that the artifact is some identifier that uniquely identifies the appliance, such as a: hardware serial number, license certificate serial number, physical network address or an artifact of an authentication server trusted by both the director and the appliance.

Besides being used to wedge open a UDP port to allow asynchronous requests from the director to the secure access appliance, the wedge message sent by the secure access appliance to the director can be interpreted as an indication of liveliness. For example (as will be described in a future disclosure) a low level driver on the director can take notice of packets operating on the UDP destination port associated with wedge packets. By interrogating the artifact, it is able to note that a particular secure access appliance is alive. Due to the possibility for loss of UDP packets over the internet, a missed packet does not constitute a failure; however, a received packet does confirm that the appliance is operational.

Besides being used as a means to send unsolicited requests for heartbeats, the present protocol could be extended to send other asynchronous messages.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an architectural overview of a virtual services infrastructure;

FIG. 2 is a schematic view of a firewall preventing access to a remote device;

FIG. 3 is a schematic view of a wedge packet sent by an appliance to a director;

FIG. 4 is a schematic view of the director sending an asynchronous message request to the appliance via a wedge message;

FIG. 5 is an example of basic encoding rules for a wedge packet and an asynchronous message;

FIG. 6 is an example of a firewall network address translation table;

FIG. 7 is an example of a director mapping artifacts to a public address/port used to resolve addresses when sending asynchronous messages;

FIG. 8 is a view showing the exchange of messages between the workstation, the director, the controller and the appliance according to the above-mentioned co-pending application;

FIG. 9 is a view showing the exchange of messages between the workstation, the director, the controller and the appliance according to the present invention.

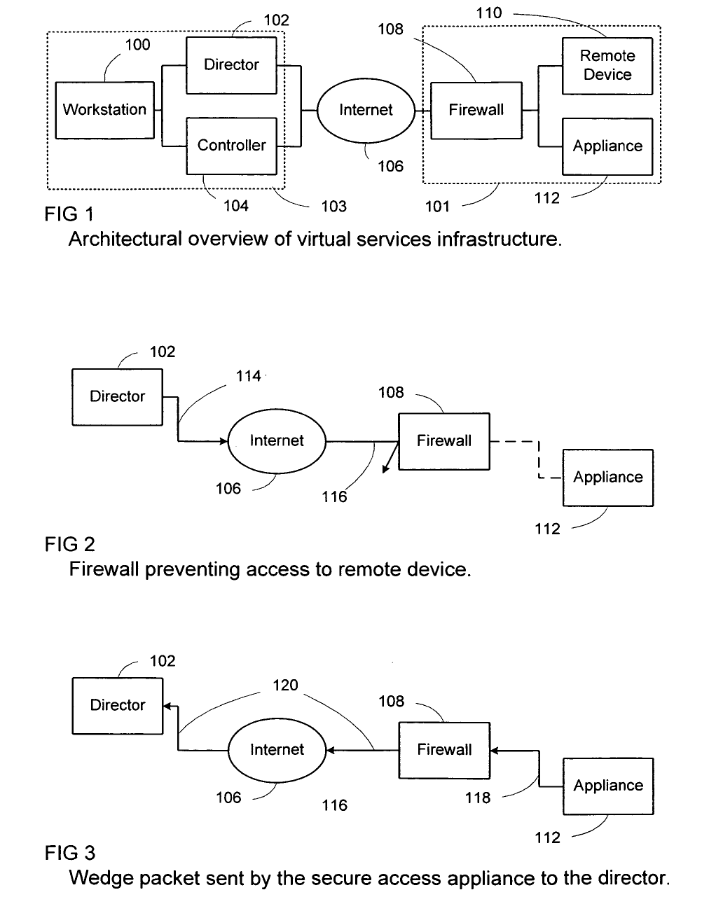

### DESCRIPTION OF THE PREFERRED EMBODIMENTS

Referring to the drawings in particular, the public computer network 106 is usually the Internet. One of the private networks is a satellite network 101 which is connected to the public network 106. Inside the satellite network 101 is the remote device 110, which is usually one of the devices being controlled. A firewall 108 is arranged in the satellite network 101 to prevent unauthorized access to the satellite network from the public network 106, and especially to the remote device 110. A secure access appliance 112 (appliance) is also arranged inside the satellite network 101, and the appliance 112 helps create the directed circuit.

Another private network is the director network 103 which is also connected to the public network 106. Inside the director network 103 is the workstation 100, preferably where a human operator monitors and maintains the system, especially the remote device 110. The workstation 100 connects to the director 102 and the controller 104. The director and controller are in charge of receiving the request for the directed circuit and then establishing and maintaining the directed circuit with the appliance 112.

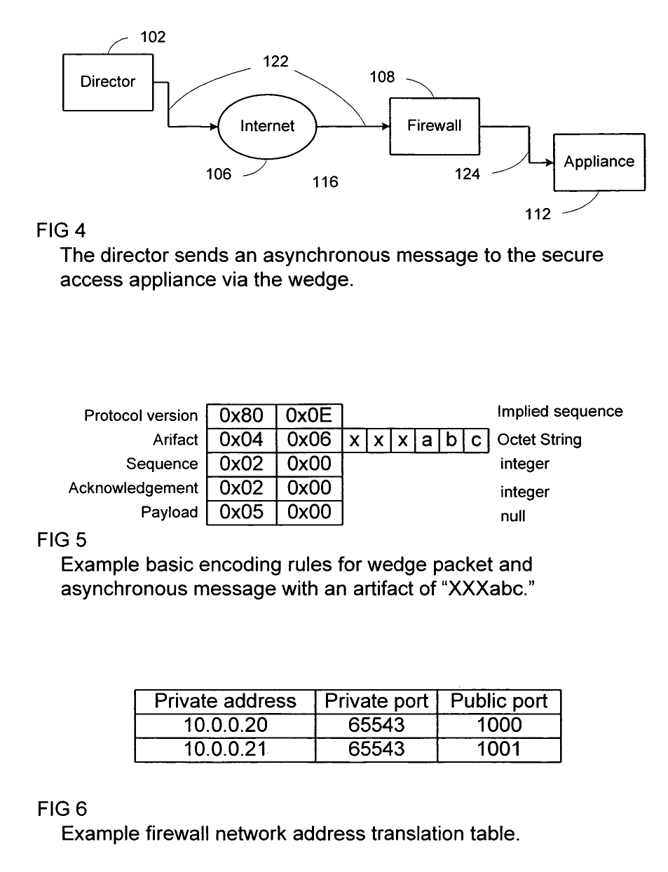

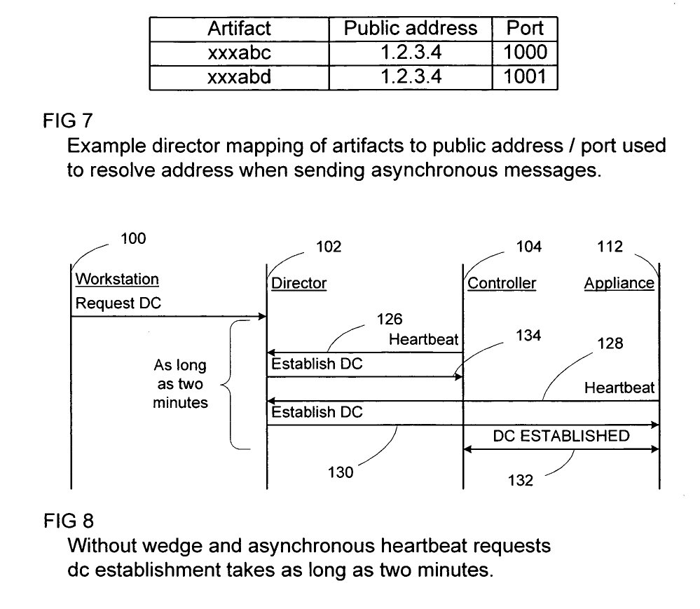

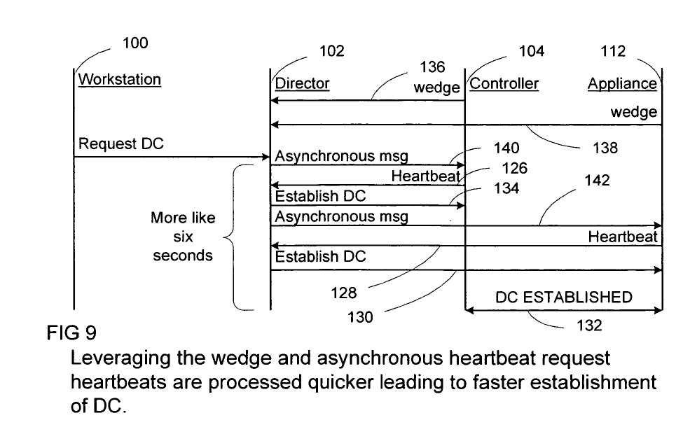

If the director 102 were to try to send an unrequested command 114 to the appliance 112, as shown in FIG. 2, the firewall 108 would block the message 116 when it was received from the public network 106. However if the appliance 112 sends a message 118 to the director 102 through the firewall 108, the firewall will convert the message 118 into an Internet message 120 which will pass through the public network 106 to the director 102. The director 102 can then send a reply message 122 through the public network 106 to the firewall 108. The firewall 108 is configured to pass reply messages, and sends the reply message 122 to the appliance 112 as message 124. This is shown in FIGS. 3 and 4.

As shown in FIG. 8, the workstation 100 sends a request for a directed circuit to the director 102. The director 102 then waits for a status or heartbeat message 128 from the appliance 112. The director 102 can then send a response message 130 back to the appliance 112 requesting that the appliance 112 establish a directed circuit 132.

In order to securely establish the directed circuit 132, the director 102 must first wait for a status or heartbeat message 126 from the controller 104. After the director 102 receives the heartbeat message 126, the director 102 sends a response message 134 to the controller 104 directing the controller 104 to establish the directed circuit 132 with the appliance 112. For higher security, the director 102 first responds to the heartbeat message 126 from the controller 104, and then responds to the heartbeat message 128 from the appliance 112. If the heartbeat messages 126 and 128 are sent independently of each other, and each is sent once a minute, it can take as long as two minutes to establish the directed circuit 132.

In order to avoid this long delay, the present invention has the appliance 112 send a second type of message 138 to the director 102. This second type of message 132 is preferably a UDP (User Datagram Protocol) message which is preferably smaller in size than the first type status or heartbeat messages 126 and 128. This allows the second type message to be sent more frequently without creating the large burden that would occur if the first type status/heartbeat message was sent more frequently. The second type message is often called a wedge message. When the director 102 receives the second type message 138, the director 102 is then able to send a second type return/response message 142 to the appliance 112. This second type return message 142 is a request to the appliance 112 to prematurely, preferably immediately send the first type status/heartbeat message 128 to the director 102. The second type return message is often called an asynchronous message since it is sent only to request an immediate sending of the first type status/heartbeat message.

Because of security reasons, the controller 104 also sends second type messages 136 to the director 102. The director 102 can then send a second type return message 140 to the controller 104 requesting an immediate status/heartbeat message 126. The director 102 can respond to the status/heartbeat message 126 in the usual manner. Since the second type messages are smaller, more easy to process, and send more frequently, the use of the second type messages 136 and 138 greatly decrease the time, on average, needed to establish a direct circuit 132.

The second type messages 136 and 138 are preferably formed from the following ASN.1 fragments which define a portion of a protocol used to form the packets of the second type messages 136 and 138.

Packet::=CHOICE OF {version0Packet Version0Packet}

Version0Packet::=[0] SEQUENCE OF {artifact OCTET STRING, sequence INTEGER, ack INTEGER, //Sequence Acknowledgement payload PayloadType}

PayloadType::=CHOICE OF {implied [0] NULL, //Contextual meaning.}

When this protocol is used for the purpose of the wedge packets both the sequence and the acknowledgment fields are set to zero. Furthermore the implied payload type is used. When sent by an appliance to the director, the packet signifies a wedge and the director acts on this packet by recording the source address and port from which the packet was sent (NATed) along with the artifact. Later, when the director wants the appliance to force a traditional HTTP based heartbeat, it will send the implied wedge packet back to the appliance via the recorded source address and port. In this case, the director will place its own artifact in the artifact field.

While specific embodiments of the invention have been shown and described in detail to illustrate the application of the principles of the invention, it will be understood that the invention may be embodied otherwise without departing from such principles.

What is claimed is:

1. A secure network arrangement comprising:
a public network;
a director connected to said public network;
a firewall connected to said public network;
an appliance connected to said second side of said firewall, said appliance periodically sending a first type message through said firewall and through said public network to said director, said appliance periodically sending a second type message through said firewall and through said public network to said director;
said firewall blocking direct access from said public network to said appliance, said firewall passing a response to said first type messages from said public network to said appliance, said firewall being open to pass a return message to said second type message from said public network to said appliance for a time period after an initial said second type message, said time period of said firewall for said return message being longer than a time of a response to said first message;
said director sending said return message to said appliance within said time period;
upon said appliance receiving said second type asynchronous request message, said appliance prematurely sending a next said first type message.

2. And arrangement in accordance with claim 1, wherein:
said return message is a specific request for said premature first type message.

3. An arrangement in accordance with claim 1, wherein:
said first type message includes a status report.

4. An arrangement in accordance with claim 1, wherein:
said administrator responds to said premature first type message with a request to create a directed circuit.

5. An arrangement in accordance with claim 1, wherein:
said first type message is an HTTP message.

6. An arrangement in accordance with claim 1, wherein:
said second type message is an UDP message.

7. An arrangement in accordance with claim 4, wherein:
said first type message is an HTTP message.

8. An arrangement in accordance with claim 7, wherein:
said second type message is an UDP message.

9. An arrangement in accordance with claim 5, wherein:
said second type message is an UDP message.

10. An arrangement in accordance with claim 1, wherein:
said first type message is a UDP message.

11. An arrangement in accordance with claim 6, wherein:
said second type message is a UDP message encapsulating an ASN.1 encoded document.

12. An arrangement in accordance with claim 8, wherein:
said UDP message encapsulates an ASN.1 encoded document.

13. An arrangement in accordance with claim 10, wherein:
said UDP message encapsulates an ASN.1 encoded document.

14. An arrangement in accordance with claim 1, further comprising:
a controller connected to said public network, said controller periodically sending a controller first type message to said director at a first controller frequency, said controller periodically sending a controller second type message to said director at a second controller frequency, said second controller frequency being faster then said first controller frequency, said controller receiving a controller second type asynchronous request message from said director;
upon said controller receiving said second type asynchronous request message, said controller prematurely sending a next said controller first type message.

15. An arrangement in accordance with claim 14, wherein:
said director responds to one of said first type messages with an instruction to said controller and said appliance to create a directed circuit between themselves.

16. An arrangement in accordance with claim 15, wherein:
said controller and said appliance create a directed circuit between themselves when instructed by said director.

17. An arrangement in accordance with claim 1, wherein:
said time period of said firewall for said return message is longer than a maximum time of a response to said first message.

18. An arrangement in accordance with claim 1, wherein:
said second type message being sent periodically at a frequency, said frequency of said second message and said time period of said firewall being arranged to have said firewall be open to return messages longer than said firewall allows a response to said first type message.

19. An arrangement in accordance with claim 18, wherein:
said frequency and said time period being arranged to have said firewall be open substantially constantly.

20. An arrangement in accordance with claim 1, wherein:
said second type message is shorter than said first type message.
